(19) United States
(12) Patent Application Publication
(10) Pub. No.: US 2005/0149396 A1
(43) Pub. Date: Jul. 7, 2005

(54) Online advertising system and method

(75) Inventors: Russell C. Horowitz, Seattle, WA (US); Peter Christothoulou, Seattle, WA (US); Ethan Caldwell, Seattle, WA (US); John Keister, Seattle, WA (US); Walter Korman, Seattle, WA (US); Yang Lim, Seattle, WA (US); John Busby, Seattle, WA (US)

Correspondence Address: NIXON PEABODY, LLP, 401 9TH STREET, NW, SUITE 900, WASHINGTON, DC, 20004-2128, US

(73) Assignee: MARCHEX, Inc., Seattle, WA (US)

(21) Appl. No.: 10/992,366

(22) Filed: Nov. 19, 2004

Related U.S. Application Data
(60) Provisional application No. 60/523,688, filed on Nov. 21, 2003.

(51) Int. Cl. G06F 17/60

(52) U.S. Cl. 705/14; 705/400

(57) ABSTRACT

A system, method, and computer program product for online advertising, including generating pricing for an advertisement campaign of an advertiser paying on a Cost-Per-Click (CPC) basis or Cost-Per-Acquisition (CPA) based on internal tracking metrics and/or pricing and performance analysis of advertisements from an advertising distribution network; and distributing the advertisement as a CPC-based advertisement and/or CPA-based advertisement to an advertising distribution network.

### CROSS REFERENCE TO RELATED DOCUMENTS

The present invention claims benefit of priority to U.S. Provisional Patent Application Ser. No. 60/523,688 to HOROWITZ et al., entitled “ONLINE ADVERTISING SYSTEM AND METHOD,” filed Nov. 21, 2003, the entire disclosure of which is hereby incorporated by reference herein.

### BACKGROUND OF THE INVENTION

1. Field of the Invention

The present invention generally relates to advertising methods and systems, and more particularly to a method and system for online advertising.

2. Discussion of the Background

In recent years, methods, such as Cost-Per-1,000 (CPM), Cost-Per-Click (CPC), etc., have been developed for calculating charges for advertising online. The CPM method is a holdover from traditional media advertising and typically is an unreliable, under performing, administratively burdensome and un-targeted format for advertisers seeking to maximize Return-On-Investment (ROI) for online advertising campaigns. For example, the CPM method charges advertisers based solely on the number of times the advertisement is served (i.e., the number of impressions). The CPM method has typically been sold on the basis of delivering traffic and branding.

The CPC method charges for advertisements based on a cost associated with each selection of or click on an advertisement. CPC is a much more accountable means of developing a price for an advertisement, such as a keyword listing, text link, phrase, banner, button, pop-up or pop-under. The CPC format charges advertisers based on the volume of clicks generated by end users on the target advertisement. The number of times that an advertisement is clicked on, divided by the number of times that it has appeared is referred to as the Click-Through Rate (CTR) for the advertisement. Unlike the CPM format, the CPC format has not typically been sold with any premium built in for advertiser branding.

In addition, online advertisers have become very focused on ROI and on minimizing financial risk. Accordingly, a growing percentage of advertisers employ software tools and operational resources to attempt to accurately and regularly track ROI. Due in part to the increased understanding by advertisers of the performance of their online campaigns, the online advertising market has evolved from a largely impression-based CPM medium, where an advertiser pays for exposure, for example, including bulk advertising purchases, to a performance-based medium, such as via CPC campaigns, for example, where an advertiser pays for end-user click-throughs to a designated Web page or Web site. As a result of such an evolution, average advertiser ROI for online campaigns had risen from 12% for advertisers who use CPM-based campaigns to 29% for those employing CPC alternatives, according to one study.

Based on the higher targeted ROI potential of CPC campaigns, acquisition costs, and ROI measurement, CPC advertising has captured an increasing percentage of the advertising dollars from the CPM market. Therefore, the industry analysts believe that over the next number of years, the majority of advertising dollars will be spent on CPC campaigns.

Pay-for-performance (PFP) advertising has become a successful means for capturing CPC dollars from advertisers. Pay-for-performance advertising typically involves a targeted advertising campaign, via a pay-for-performance search engine (PFPSE), wherein an advertiser can pay on a CPC basis for clicks that deliver a user to a designated Web page or Web site. The pay-for-performance search engine can aggregate advertisements in the form of paid listings that relate to specific keywords and also can reference distribution partners to display such paid listings. A paid listing can include descriptive words, phrases or sentences, which are related to an advertiser product, service or business. Paid listings can be displayed in several forms, including a paid listing or search result included among other search results displayed on a search engine. Paid listings also can be delivered on other types of Web sites, for example, in the form of a text-based advertisement delivered within a banner or button or some other means of display.

When paid listings are delivered by pay-for-performance search engines to distribution partners, such as other search engines, etc., the paid listings typically are delivered in ranked orders according to CPC. The pay-for-performance search engines order the paid listings according to the CPC each advertiser has predetermined, with the advertisement or listing with the greatest designated CPC presented as the first result that is returned among the search results for a particular keyword or phrase and with the remaining paid advertisements or listings displayed in descending order according to the designated CPC for such keyword or phrase. For example, a pay-for-performance search engine may have twenty paid listings that will be returned as the result of a search for the term “television” and such paid listings will be displayed in descending order, beginning with the paid listing with the highest designated CPC. The twenty paid listings, also can be delivered to distribution partners, which can integrate the ranked paid listings into search results. Other distribution points for paid listings can include newsletters, related informational Web pages, pop-unders or pop-overs, and via text-based banners, buttons or other methods.

Under current methods, a majority of the pay-for-performance search engines allow advertisers to select the CPC for each paid listing. This poses a series of problems for advertisers. For example, one such problem is that an advertiser typically buys keywords from multiple pay-for-performance search engines concurrently and the competitive market within each of these pay-for-performance search engines for any particular keyword or phrase can be vastly different.

In addition, advertisers may not be sophisticated enough to factor in the ROI for a given pay-for-performance search engine. Further, an advertiser also may not have the time or insight to factor in the value or scope of the distribution network (e.g., which periodically changes as new distribution agreements are made) of a pay-for-performance search engine, when determining the CPC for a particular keyword or phrase. For example, a pay-for-performance search engine may be delivering the listings of the advertiser across hundreds of distribution partners, wherein such a distribution mix of partners can be changing on a monthly, if not daily, basis, and a #1 rank at 50 cents per click on the pay-for-performance search engine itself may not equate to a #1 ranking on certain distribution partners of the pay-for-performance search engine.

A still further problem that advertisers can face under current methods that require the advertiser to select the CPC for every paid listing, is that the advertiser must manage the CPC campaign on a real-time basis. This can be a very difficult task, given the multitude of factors that can influence the variances in the CTR for a particular advertiser, including variance in ROI due to changes in the distribution network, seasonal effects, etc.

### SUMMARY OF THE INVENTION

Therefore, there is a need for a method and system that addresses the above and other needs, while providing advertisers with the ability of running a paid listing Cost-Per-Click (CPC) or Cost-Per-Acquisition (CPA) campaign through a pay-for-performance search engine (PFPSE). The above and other needs are addressed by the exemplary embodiments of the present invention, which provide an online advertising system, method, and computer program product configured to present an advertiser with specific pricing for each placement for a given keyword, for example, based on exemplary information, such as the competitive marketplace for a given keyword, the number of advertisers interested in a given keyword, a typical Return-On-Investment (ROI) on a given keyword, changes in distribution, seasonality, time of day, other competitive data, and the like. The exemplary embodiments can set pricing for various keywords, placements within such keywords, and the like, by tracking the exemplary information, advantageously, eliminating the risk that an advertiser will buy a keyword at a variance to the prevailing market pricing and the current ROI for such a keyword.

Accordingly, in exemplary aspects of the present invention there is provided a system, method, and computer program product for online advertising, including generating pricing for an advertisement campaign of an advertiser paying on a Cost-Per-Click (CPC) basis or Cost-Per-Acquisition (CPA) based on internal tracking metrics and/or pricing and performance analysis of advertisements from an advertising distribution network; and distributing the advertisement as a CPC-based advertisement and/or CPA-based advertisement to an advertising distribution network.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary online advertising system;

FIG. 2 illustrates exemplary processes that can be performed on the exemplary online advertising system of FIG. 1;

FIG. 3 is a flowchart for illustrating an exemplary process for keyword setup and serving;

FIG. 4 is a flowchart for illustrating an exemplary process for keyword serving;

FIG. 5 illustrates an advertiser GUI window for Term Selection, according to an exemplary embodiment;

FIG. 6 illustrates the advertiser GUI window for Term Refinement, according to an exemplary embodiment;

FIG. 7 illustrates the advertiser GUI window for Super/Fixed Placement, according to an exemplary embodiment;

FIG. 8 illustrates the advertiser GUI window for Best Available Placement, according to an exemplary embodiment;

FIG. 9 illustrates the advertiser GUI window for Advertiser Budget & Throttle, according to an exemplary embodiment;

FIG. 10 illustrates a flowchart of a process for determining changes to best available keyword prices, according to an exemplary embodiment;

FIG. 11 illustrates a flowchart of a process for determining keyword placement for search results, according to an exemplary embodiment;

FIG. 12 illustrates a further exemplary online advertising system;

FIG. 13 illustrates exemplary processes that can be performed on the exemplary online advertising system of FIG. 12;

FIG. 14 is a flowchart for illustrating exemplary processes that can be performed on the exemplary online advertising system of FIG. 12; and

FIG. 15 is an exemplary computer system, which may be programmed to perform one or more of the processes of the described exemplary embodiments.

### DETAILED DESCRIPTION OF THE PREFERRED EMBODIMENTS

The present invention, thus, includes the recognition of the problem that, under current methods, a majority of pay-for-performance search engines (PFPSEs) allow advertisers to select the Cost-Per-Click (CPC) for each paid listing, which poses a series of difficulties for advertisers. For example, one problem is that an advertiser typically buys keywords from multiple pay-for-performance search engines, concurrently, wherein the competitive market within each of such pay-for-performance search engines for any particular keyword or phrase can be vastly different. Accordingly, an advertiser electing to pay for a #1 ranking for a paid listing keyword “television” may pay 50 cents for such #1 ranking on one pay-for-performance search engine, while the same #1 ranking may cost 20 cents at another pay-for-performance search engine.

Advertisers, however, may expect that the Return-On-Investment (ROI) for paid listings on various pay-for-performance search engines will be about the same, or that market forces would pressure the pricing appropriately to make up for any differences in Click-Through Rate (CTR) and ultimately the ROI. Nonetheless, transactions generated per click for a paid listing with a lower CPC may be significantly greater than the transactions generated per click for the paid listing with a greater CPC. Accordingly, advertisers currently struggle to understand the reasons for the variances in ROI and CTR in a given CPC campaign with pay-for-performance search engines.

The present invention further includes the recognition of the problem that advertisers may not be sophisticated enough to factor in the ROI for a given pay-for-performance search engine. In addition, an advertiser also may not have the time or insight to factor in the distribution costs of a pay-for-performance search engine, when determining the CPC for a particular keyword or phrase. For example, a pay-for-performance search engine may be delivering the listings of the advertiser across hundreds of distribution partners, wherein such a distribution mix of partners can be changing on a monthly, if not daily, basis, and a #1 rank at 50 cents per click on the pay-for-performance search engine itself may not equate to a #1 ranking on certain distribution partners of the pay-for-performance search engine.

In addition, advertisers currently do not have the data, nor requisite analytical resources, to maximize efficiencies in a CPC paid listing campaign with a pay-for-performance search engine. Accordingly, the exemplary embodiments include an exemplary pay-for-performance search engine configured to price, rank, and the like, a paid listing of an advertiser, appropriately, according to various factors, such as the paid listing keywords, the blended ROI information, the associated distribution costs, and the like.

The present invention further includes the recognition of the problem that current methods of requiring an advertiser to select a CPC for every paid listing results in the advertiser having to manage a CPC campaign on a real-time basis. For example, to maximize ROI, an advertiser must constantly raise, lower and monitor the CPC the advertiser is willing to pay for any particular keyword or phrase across multiple pay-for-performance search engines. This can be a very difficult task given the multitude of factors that can influence the variances in the CTR for a particular advertiser, for example, including the constantly changing market for each particular keyword, seasonality, a given distribution of a pay-for-performance search engine, changes in such distribution, relevance of the listing, differing CTR by distribution partner, fluctuation in traffic by time of day, month, season, holiday, and the like.

Many of the above factors are not understood or available to the advertiser when the advertiser makes decisions on a CPC that the advertiser is willing to pay. In addition, such factors can compound the challenges for advertisers to develop and manage measurable, accurate and predictable ROI. Further, advertisers regularly update paid listings and enter new paid listings, which, in turn, change the order of any previously existing paid listings.

The exemplary embodiments provide an evolution in the marketplace, advantageously, solving the above and other problems, wherein advertisers are presented with ranking and placement options for keyword CPC campaigns that take into account the above and other factors, for example, including the variances in keyword pricing across numerous distribution partners, the real-time competitive marketplace for each keyword, the ROI for each keyword, and the like. Advantageously, the exemplary embodiments allow advertisers to more efficiently manage, for example, paid listing CPC campaigns that are priced based on calculations made by the exemplary pay-for-performance search engine using selected data, such as CPC, CTR, competitive marketplace, seasonality, time of day, ROI for a particular keyword, and the like.

In an exemplary embodiment, the pay-for-performance search engine can be configured to set pricing on a CPC basis. In further exemplary embodiments, however, the pay-for-performance search engine also can be configured to set pricing on a Cost-Per-Acquisition (CPA) basis. In an exemplary CPC embodiment, the pay-for-performance search engine, for example, can dictate that position #1 on a given keyword costs, for example, 25 cents per click, position two costs 20 cents per click, and the like. In an exemplary CPA embodiment, the pay-for-performance search engine can dictate that position #1 on a given keyword costs, for example, $35.00 per acquisition, position #2 costs $30.00 per acquisition, and the like. Generally, conversion, CTR data, other metrics, and the like, can be employed for determining placement on CPA-based campaigns.

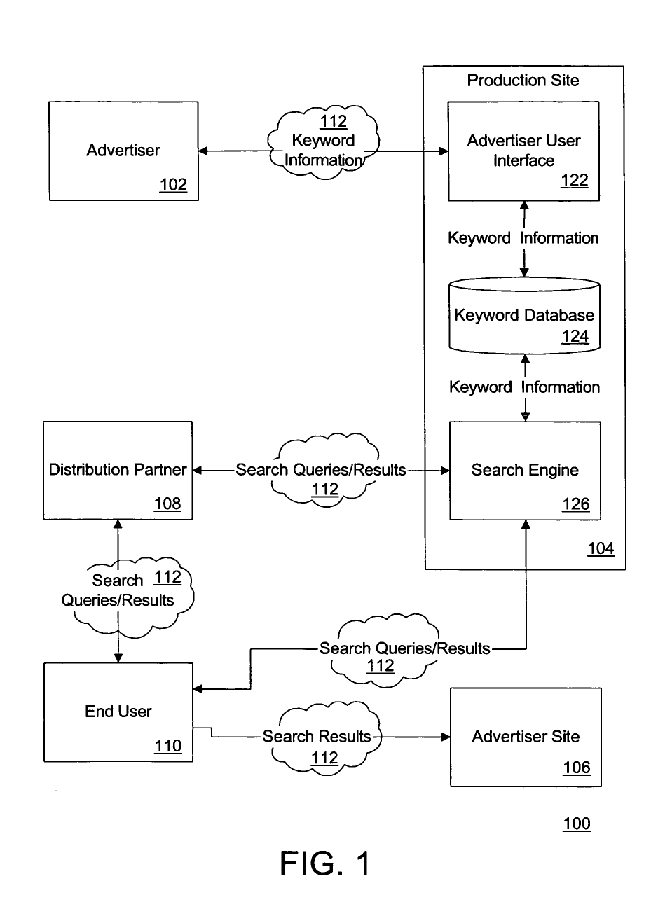

Referring now to the drawings, wherein like reference numerals designate identical or corresponding parts throughout the several views, and more particularly to FIG. 1 thereof, there is illustrated an online advertising system 100, according to an exemplary embodiment. In FIG. 1, the exemplary online advertising system 100 can include one or more Advertisers 102, a Production Site 104, an Advertiser Site 106, one or more Distribution Partners 108, one or more End Users 110, and one or more computing devices thereof. The Production Site 104 can include an Advertiser User Interface 122, a Keyword Database 124, and a Search Engine 126. The one or more computing devices of the Advertisers 102, the Production Site 104, the Advertiser Site 106, the Distribution Partner 108, and the End Users 110 can communicate with each other over a communications network 112, such as the Internet.

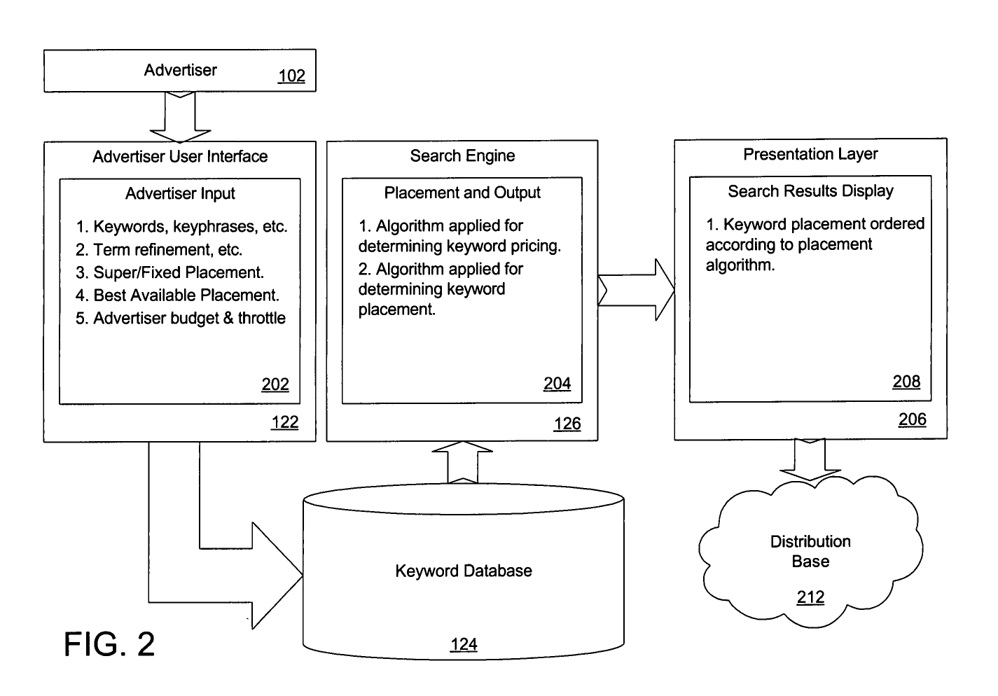

FIG. 2 illustrates exemplary processes that can be performed on the exemplary online advertising system 100 of FIG. 1. In FIG. 2, the Advertisers 102 can employ an Advertiser Input process 202 of the Advertiser User Interface 122, for example, to input keywords, keyphrases, and the like. The Search Engine 126 can employ a Placement and Output process 204, for example, to determine an algorithm applied for determining keyword pricing, placement, and the like. A presentation layer 206 can employ a Search Results Display process 208, for example, to place the keywords of the Advertisers 102 according to the placement algorithm, to display output search results according to the placement, and the like. The search results can be output by the presentation layer 206 to a Distribution Partner 108 or a Distribution Base 212.

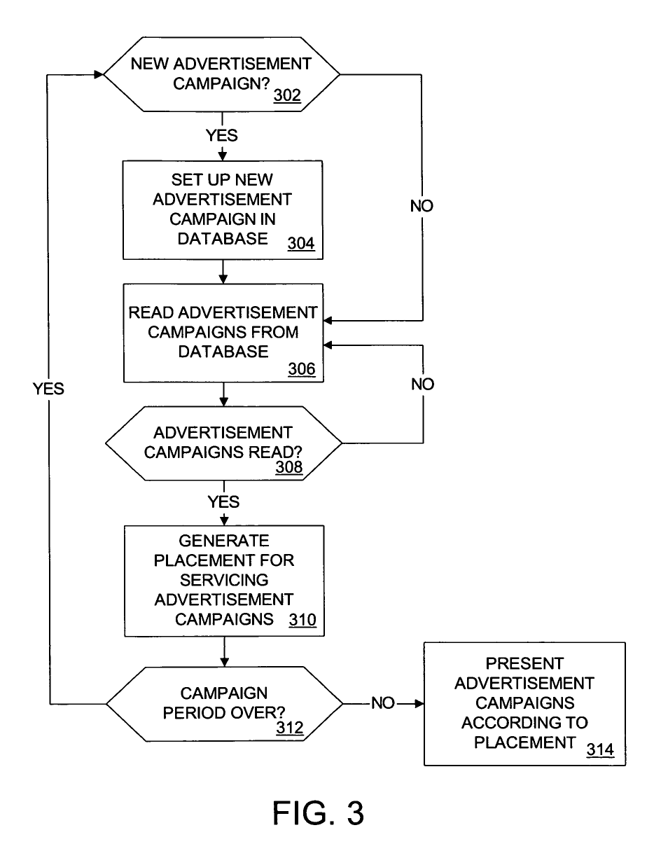

FIG. 3 is a flowchart for illustrating an exemplary process for keyword setup and serving. In FIG. 3, keyword setup and preparation for serving can include determining at step 302 whether or not a new advertisement campaign has been set up. If so, at step 304, the new advertisement campaign can be integrated into the Keyword Database 124, for example, taking into account the various items entered by the Advertisers 102 into the Advertiser User Interface 122.

At step 306, the Search Engine 126 can read the advertisement campaign information from the Keyword Database 124, as determined by step 308. The exemplary online advertising system 100 can then employ a suitable algorithm to determine the appropriate placement, and the like, for the keywords of the Advertiser 102. At step 310, for example, on an ongoing periodic basis, as determined by step 312, the Search Engine 126 can generate a new placement for the keywords of the advertisement campaigns, and the like. At step 314, search results of the exemplary online advertising system 100 can be presented based on the purchased placement. The exemplary online advertising system 100 then can distribute the search results based on the purchased placement to a distributor or end user based on any suitable algorithm.

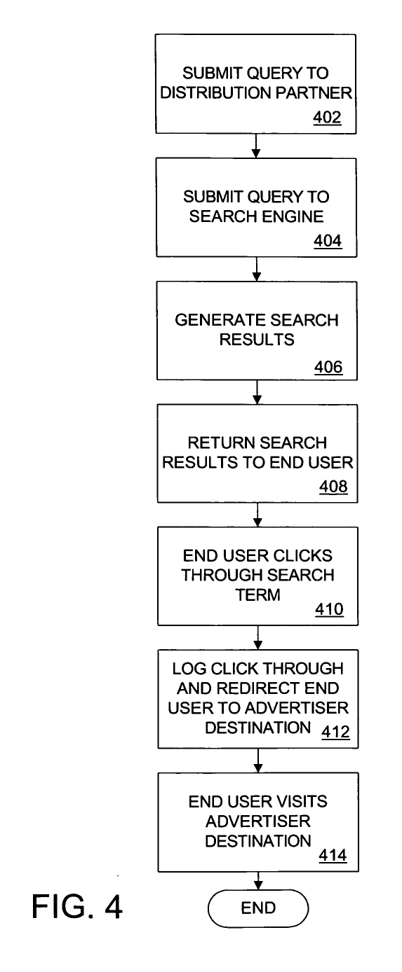

FIG. 4 is a flowchart for illustrating an exemplary process for keyword serving. In FIG. 4, at step 402, in an exemplary keyword serving case, the End User 110 submits a Query to the Distribution Partner 108. At step 404, the Distribution Partner 108 submits the Query to the Search Engine 126. At step 406, the Search Engine 126 returns search results with corresponding keyword placement chosen for display, and logs the query and associated keywords that were served. At step 408, the Distribution Partner 108 returns the search results to the Web browser of the End User 110. At step 410, the End User 110 clicks-through one of the keyword links. In a further exemplary embodiment, the End User 110 can query the Search Engine 126 directly without going through the Distribution Partner 108.

At step 412, the Search Engine 126 can log the click-through on the keyword and redirect the Web browser of the End User 110 or pop up a new Web browser for the End User 110 to the destination (e.g., Web page, Web site, landing page, and the like) of the Advertiser Site 106 corresponding to the selected keyword. At step 414, the End User 110 can visit the Advertiser Site 106 based on the selected keyword. In an exemplary embodiment, the Search Engine 126 also can log the acquisitions for an advertiser, which can be used to determine performance based relevance during placement and for keyword pricing.

Thus, according to the exemplary embodiments, a keyword-based, fixed-price, online advertising system and method are provided, for example. In an exemplary embodiment, prices can be fixed or set by the exemplary system 100 in an automated, on-the-fly, manner, and the like.

In an exemplary embodiment, the exemplary system 100, for example, configured as an online system, can be employed to sell keywords, buckets of keywords (e.g., keywords related to “Cars”), and the like, and/or for fixed placements based on payment by the advertiser 102 over a specific period of time. For example, in selling of the keyword “cars,” the exemplary system 100 can be configured to charge $0.35 for placement 1, $0.30 for placement 2, $0.25 for placement 3, $0.20 for placement 4, $0.10 for placement 5, $0.05 for placement 6-100, and the like. Placement 6-100, for example, can be determined by which advertiser buys first. In further exemplary embodiments, any other suitable prices and/or placement ranges can be employed.

In an exemplary embodiment, the following rules can be employed:

If an advertiser buys placement 6, and no one buys placements 1-5, then that advertiser can be in placement 1 for the corresponding period of time.

Automated, on-the-fly, pricing can be set, for example, by taking into account current pricing for a given keyword or keyword bucket, based on current pricing of other paid-listings services, availability of a given word, e.g., based on demand, performance, including conversions and acquisitions, clickthrough rate, and the like.

Advertisers 102 can buy for a period of, for example, up to a predetermined period (e.g., daily, monthly, every 3 months, etc.) at a set cost-per-click (CPC), wherein different CPC levels within the predetermined period for certain seasonal words or words that are rising continually in price can be employed.

Advertisers 102 can be offered the opportunity to buy a given keyword slot for a fixed dollar amount or for a fixed amount of time. In an exemplary embodiment, the exemplary system 100 can be configured to provide an estimate for costs, if an advertiser purchases on a time-period basis.

The exemplary system 100 provides a simple system for advertisers to understand.

In an exemplary embodiment, implementation, technical assessment, timelines, objectives, and the like, for the exemplary system 100, for example, can include:

Providing simplicity for the advertiser.

Allowing for the exemplary system 100 to be plugged into an existing system.

In an exemplary embodiment, incorporation of current prices and demand of paid listing services can be employed, wherein automatic, intelligent, monitoring of a subset of important keywords of other paid listing services can be performed to keep a read on competitive pricing trends. In a further exemplary embodiment, a human can be employed to check such words periodically.

In an exemplary embodiment, the exemplary system 100 can include inventory management functions to take into account, for example, an advertiser who buys slot 1 on a high-volume keyword, and only spends $20. In this case, such an advertiser can be given the option to be in and out in one day or spread the cost out over 1-2 months (e.g., every 5,000^{th} search for “car”).

In an exemplary embodiment, a hybrid approach can be provided, for example, that factors in clicks, relevancy, and the like, in the placement process. For example, a relevancy formula can be employed for advertisers paying 5 cents or less.

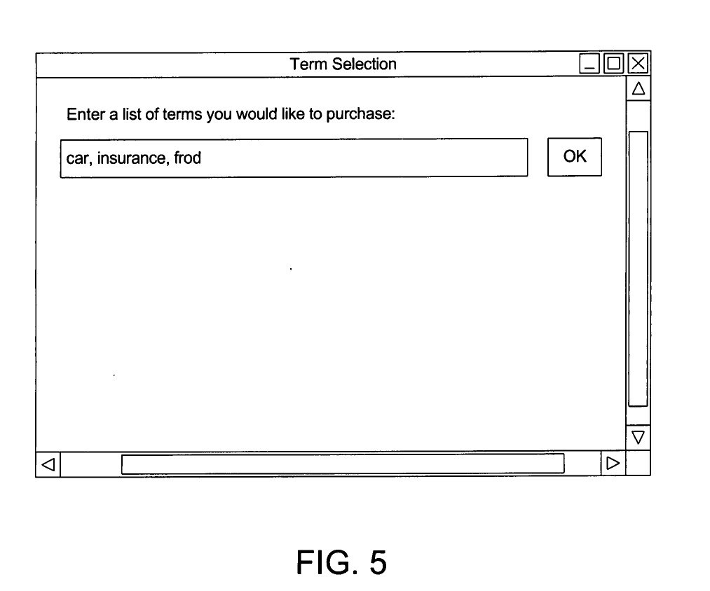

In an exemplary embodiment, a graphical user interface for an advertiser, for example, the Advertiser User Interface 122, can be provided by the exemplary system 100. FIG. 5 illustrates an advertiser GUI window for Term Selection, according to an exemplary embodiment. In FIG. 5, the exemplary GUI window can include a field for entering a list of terms (e.g., separated by commas) that an advertiser would like to purchase, an OK button for submitting the list to the exemplary system, and the like.

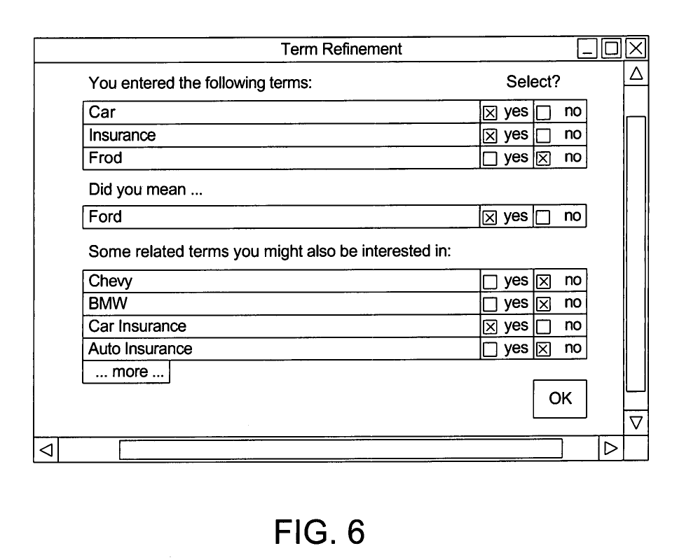

FIG. 6 illustrates the advertiser GUI window for Term Refinement, according to an exemplary embodiment. In FIG. 6, the exemplary GUI window can include one or more fields for confirming the list of terms that the advertiser would like to purchase, one or more fields for providing possible corrections to misspelled terms and confirmations for same, one or more fields for selecting related terms the advertiser might also be interested in, an OK button for submitting the selected information, and the like.

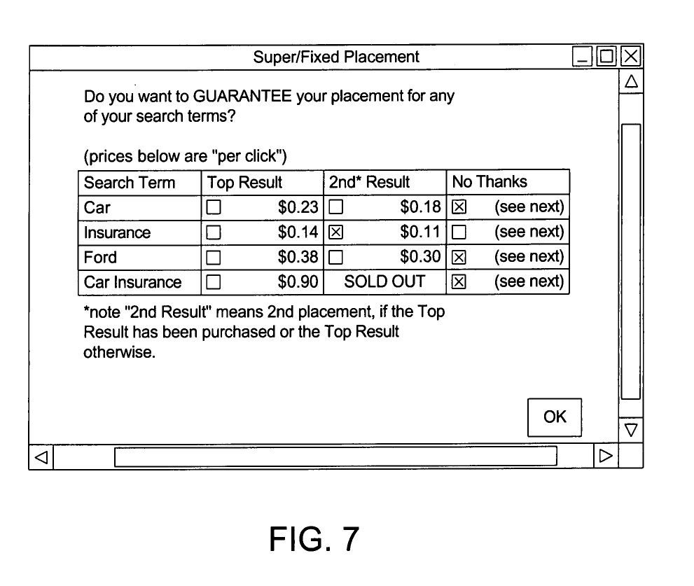

FIG. 7 illustrates the advertiser GUI window for Super/Fixed Placement, according to an exemplary embodiment. In FIG. 7, the exemplary GUI window can include one or more fields for selecting guaranteed placement for any of the search terms entered by the advertiser, an OK button for submitting the selected information, and the like. In a further exemplary embodiment, one or more fields can be provided for selecting more than two “fixed” placements, a “best available” placement, and the like. In a still further exemplary embodiment, the Super/Fixed Placement can include a time-based limit.

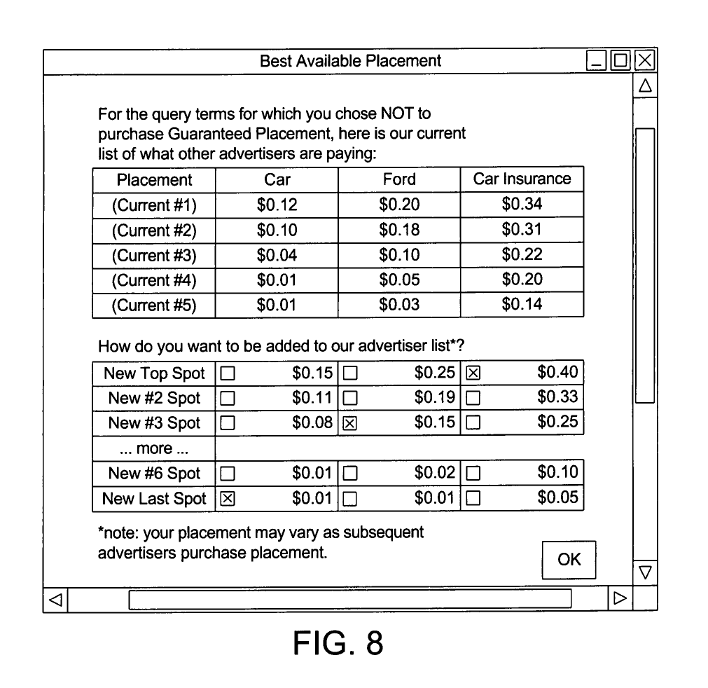

FIG. 8 illustrates the advertiser GUI window for Best Available Placement, according to an exemplary embodiment. In FIG. 8, the exemplary GUI window can include one or more fields for displaying current prices other advertisers are paying for query terms for which the advertiser chose not to purchase Guaranteed Placement, one or more fields for selecting how the advertiser is to be added to the advertiser list of the exemplary system, an OK button for submitting the selected information, and the like. In a further exemplary embodiment, one or more fields can be provided for embedding the “new spot” options available for selection directly in the “current list” rather than showing such fields separately.

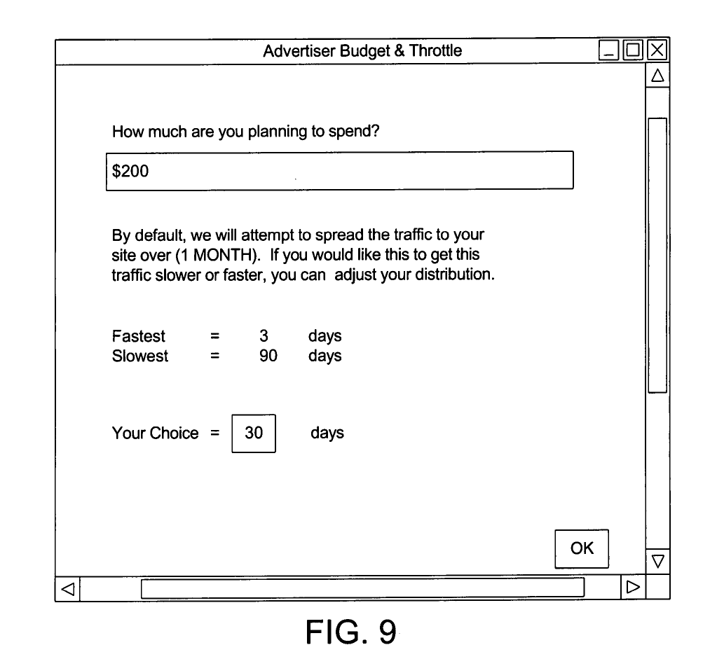

FIG. 9 illustrates the advertiser GUI window for Advertiser Budget & Throttle, according to an exemplary embodiment. In FIG. 9, the exemplary GUI window can include one or more fields for entering how much the advertiser is planning to spend, one or more fields for selecting a time period for which the exemplary system can attempt to spread traffic to the advertiser site, an OK button for submitting the selected information, and the like.

In an exemplary embodiment, initial pricing for the various keywords or buckets of keywords can be determined based on seeding the database 124 of the exemplary system 100 with initial prices (e.g., based on a per click basis) for each search term in the “best available” placement. For example, such seed values can be determined based on the average price paid for each keyword over the past month in existing advertisement systems.

In an exemplary embodiment, prices can be updated automatically, for example, based on a Keyword Pricing Engine capable of running in a fully automated mode. In a further exemplary embodiment, an Administrative Interface can be provided, for example, which sales, executive, technical users, and the like, can access to manually change prices and/or inventory for the exemplary system 100. The overarching goal of the exemplary automated system 100 can be to maximize revenue given an existing click inventory. For example, on a predetermined schedule (e.g., on an hourly basis), the exemplary system 100 can be configured to reassess the available inventory, keyword usage, pricing, and the like.

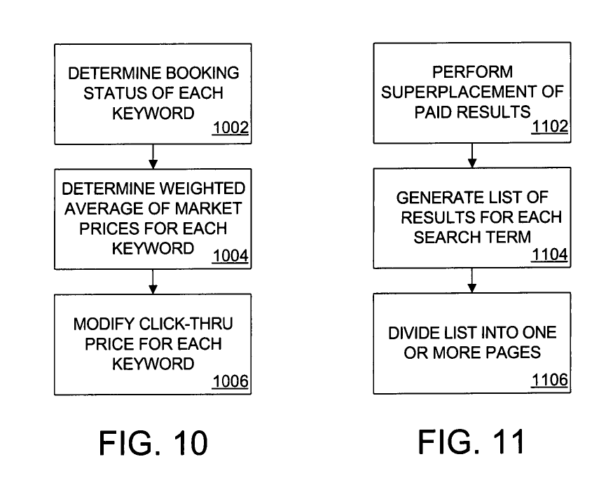

FIG. 10 illustrates a flowchart of a process for determining changes to best available keyword prices, according to an exemplary embodiment. In FIG. 10, at step 1002, the Booking Status of each keyword can be determined, for example, including Overbooked, Booked, Under-booked, Low-value, and the like, keywords. In an exemplary embodiment, Overbooked keywords can include keywords for which the exemplary system 100 has sold all of the corresponding Click Inventory for a predetermined Time Period (e.g., one month) and for which the exemplary system 100 had to move a corresponding campaign to less expensive keywords in order to maximize use of the inventory. Booked keywords can include keywords for which the exemplary system 100 has sold the corresponding inventory, but for which the exemplary system 100 has not had to Balance Out any campaigns. Under-booked keywords can include keywords for which the exemplary system 100 has sold some, but not all, of the available corresponding inventory. Low-value keywords can include keywords for which the exemplary system 100 has not sold any advertisements, wherein Run of Network advertisements can still be shown for such keywords. In further exemplary embodiments, day-parting, week-parting, and the like, can be employed.

At step 1004, a weighted average of Market Prices for each keyword can be determined. In an exemplary embodiment, each of the Market Data Sources employed can be assigned a Relevancy Weighting value from 0% to 100%, wherein this step can be performed once for each source, but can be modified via the Administrative Interface. An automated “robot” or “bot,” “spider,” and the like, can be employed and configured to grab prices for all relevant keywords from Web sites of each of the Market Data Sources. In a further exemplary embodiment, a human can be employed to gather such prices manually or semi-automatically from the Market Data Sources. The weighted Market Average can be assigned for each keyword by multiplying each Market Price by the Source Weight, and normalizing the result. In further exemplary embodiments, an Application Programming Interface (API) or back-channel to the Market Data Sources and others sources can be employed, wherein pricing information for relevant keywords can be collected. In an exemplary embodiment, a program can be configured to collect market pricing data from such sources, for example, through a feed of some sort that can be accessed or through an API to a market data source. In further exemplary embodiments, an alternate feed of the Market state can be employed, wherein, via a contract, paid placement engines provide a feed (e.g., live, in bulk periodically, etc.), which can be integrated into the analysis.

At step 1006, the Click-Through price for each keyword can be modified. In an exemplary embodiment, competitive market data along with general performance data on keywords can be employed to determine pricing. For example, an Overbooked keyword can be raised by 10%, if the current price is 80% of the Market Average or higher. Otherwise Overbooked keyword can be raised by 20%. A Booked keyword can be raised by 5%, if the current price is 80% of the Market Average or higher. Otherwise, Booked keyword can be raised by 10%. An Under-booked keyword price can be left unchanged, regardless of the Market Average price. A Low-value keyword price can be lowered by 5%, but can go no lower than a Minimum Keyword Price. In a further exemplary embodiment, over-performing and under-performing keywords can be determined based on performance metrics defined to determine the strength and user-demand for keywords.

In an exemplary embodiment, top placement can be configured at first predetermined percentage (e.g., 50%) more than best available placement, and second placement can be at second predetermined percentage (e.g., 20%) more than best available placement, and the like. In a further exemplary embodiment, such a strategy can be scaled to an arbitrary number of Super Placements.

FIG. 11 illustrates a flowchart of a process for determining keyword placement for search results, according to an exemplary embodiment. In an exemplary embodiment, ranking of search results on each results page can be determined automatically by the exemplary system. In FIG. 11, at step 1102, Super Placement of paid results that are an exact match to a query can be displayed, for example, if the results have a Throttle Value of 1.0 or above.

At step 1102, for each search term (e.g., keyword or keyphrase), a master list of results can be generated, for example, ordered by Placement Value. In an exemplary embodiment, the Placement Value can include a ranking of advertisements based on normalization (e.g., Observed Relevance * Expected Return). Accordingly, a mix of relevance and price can be used to ultimately determine placement. The Observed Relevance of an advertisement can be derived from a Full Text Index of the target URL of the advertiser. For example, relevance can be determined based on characteristics, such as keywords present in a Full Text Index, other keywords commonly found with such keywords, a domain name, a page title, and the like. The Observed Relevance can be calculated, for example, at buy time or can be periodically refreshed for each advertiser that purchased the corresponding keyword. In an exemplary embodiment, Boolean operators also can be applied in this step. For example, with respect to keyword targeting, “dog AND cat” would return the corresponding matching advertisement results. The Expected Return can be calculated, for example, as:
(Click-Through Price*Click-Through Rate)*Throttle Value

In further exemplary embodiments, other types of performance-based relevance, for example, using a combination of CTR rate and/or acquisitions, which would affect a listing's placement, can be employed. For example, based on performance of results, better statistics would mean more relevance, and more likely expected returns.

In an exemplary embodiment, each advertisement can be assigned a Throttle Value between a predetermined range (e.g., 0-infinity, etc.). In an exemplary embodiment, the Throttle Value can be time-based and equal to a percentage of time remaining in a campaign divided by a percentage of actual clicks remaining, which is then multiplied by a dampening value in a predetermined range (e.g., from 0.0-1.0), and, for example, as given by:
Throttle Value=(% of campaign remaining/% of clicks remaining)×dampening value.

In an exemplary embodiment, the dampening value can be set in the predetermined range (e.g., 0.0-1.0) depending on various factors, such as seasonality, how much of the corresponding campaign has currently been spent, and the like. The following Table describes exemplary descriptions for various values for the Throttle Value.

Table of Values for the Throttle Value

| Throttle Value (x) | Description |
|---|---|
| 0 <= x < 1.0 | Campaign behind schedule |
| x = 1.0 | Campaign on schedule |
| x > 1.0 | Campaign ahead of schedule |

In an exemplary embodiment, the Click-Through rate can be general to the corresponding advertisement or specific to the corresponding advertisement/search-query pair, depending on how scarcely populated is the database 124. In a further exemplary embodiment, the Click-Through rate can be placement specific. For example, the calculation, tracking, and the like, of the Click-Through rate can be based on advertisements shown in a specific placement or for a specific advertiser, etc., wherein the Click-Through rate analysis by a scheduling algorithm can take into account such specifics as well.

At step 1106, the master list can be divided in to a series of results pages. In an exemplary embodiment, paid results that are even slightly relevant can be returned, although a distribution partner can request a limit to the number of results and a finite number of results can appear on each results page. In further exemplary embodiments, users can purchase advertisements without editorial review, a Click-Through rate minimum can be specified for an advertisement to maintain a Super Placement spot, and the like.

Thus, the exemplary embodiments can include (i) prioritizing and/or serving an advertisement for an advertiser paying on a CPC basis, CPA basis, and the like, based on an option the advertiser has chosen or based on pricing fixed by a PFPSE, (ii) tracking a number of clicks that are generated by the advertisement, and a time of actual conversion or acquisition, including a deferred conversion (e.g., via a conversion-tracking pixel or code, a back-channel for advertisers to submit conversions, etc.), (iii) tracking standard conversions that occur during a session in which a user clicks on a relevant advertisement, (iv) distributing CPC-based advertisements, CPA-based advertisements, and the like, to Internet-based advertising distribution networks, including cost-per-1,000 (CPM) advertising distribution networks, CPC advertising distribution networks, CPA advertising distribution networks, and the like, (v) delivering CPC-based advertisements, CPA-based advertisements, and the like, in a variety of formats, including a CPC-equivalent format, a CPM-equivalent format, a CPA format, and the like, (vi) tracking end user click-throughs, conversions, acquisitions, and the like, associated with an advertisement, including tracking the end user, directly tracking conversion information on a site of an advertiser, an advertiser passing conversion information back to an advertising server, and the like.

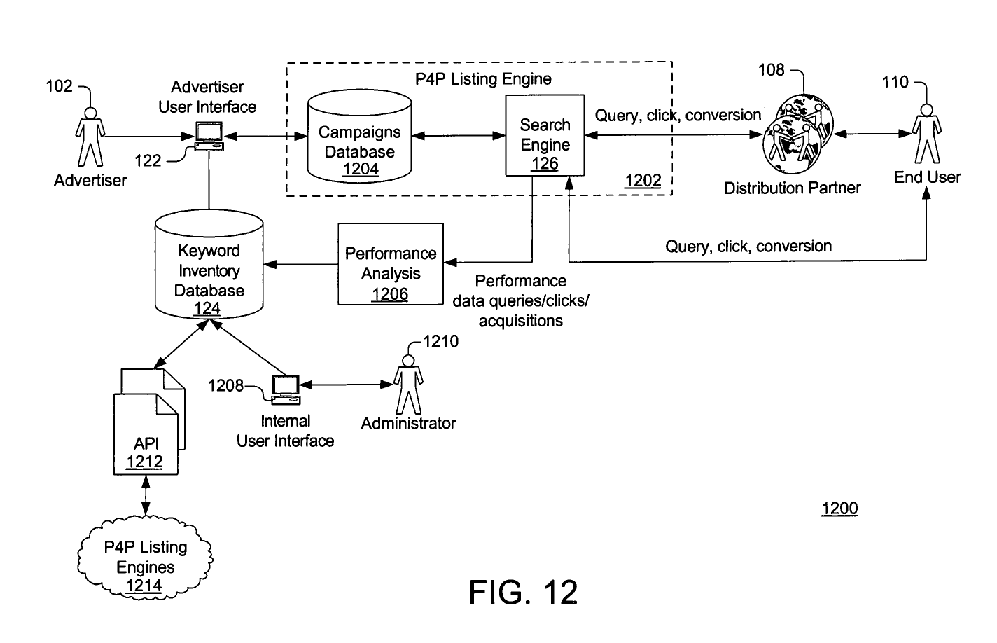

FIG. 12 illustrates a further exemplary online advertising system 1200, and which can operate in a similar manner as the exemplary system 100 of FIG. 1. In FIG. 12, the exemplary online advertising system 1200 can include the Keyword Inventory Database 124, including competitive market pricing data, performance data, and the like, for keywords, phrases, and the like, that the advertisers 102 can associate with campaigns, listings, and the like, of the advertisers 102. In an exemplary embodiment, the competitive market data can include keyword pricing information based on analyzing Pay for Placement (P4P) Listing Engines 1214 through corresponding APIs 1212, programs, and the like, configured to collect pricing information to determine relative demand, strength, and the like, for keywords in the P4P Listing Engines 1214.

In an exemplary embodiment, the performance data can include tracking of keyword/phrase strength, demand, and the like, based on a Performance Analysis component 1206 configured to analyze query, impression, click, conversion, and the like, traffic data of specific keywords/phrases to determine various metrics, such as clickthroughs per impression rates, conversions per clickthrough rates, keyword/phrase rank at different CPCs, and the like. The traffic data can be harvested from a P4P Listing Engine 1202, including the Search Engine 126, where access and ability to analyze such data is possible. Such data also can be acquired, purchased, and the like, from other sources, such as the P4P Listing Engines 1214, other search engines, and the like.

In an exemplary embodiment, the Keyword Inventory Database 124 also can be managed, altered, and the like, by an Administrator 1210 through use of various tools, such as an Internal User Interface 1208, and the like. Such a feature can be employed to allow human intervention for adding keyword pricing information for keywords that do not have competitive pricing, performance, and the like, data to begin with, to manually adjust pricing for keywords, and the like.

In an exemplary embodiment, the Performance Analysis component 1206 for query, impression, click, conversion, and the like, traffic data analysis attempts to determine relative keyword/phrase strength, demand, and the like, by taking into account the information related to the listing that was served, clicked, converted, and the like, such as the matching keyword, the rank of the listing in the result set of listings, the CPC amount the listing was shown in the result set, clickthroughs per impression rate, conversions per clickthrough rate, and the like. Such metrics can shed light on valuable market data, such as how well particular keywords at certain CPC levels receive clickthroughs and ultimately convert for the Advertiser 102.

In an exemplary embodiment, such performance data that is captured also can be associated with a specific P4P listing engine. In an exemplary embodiment, such performance data for keywords, phrases, and the like, can be stored in the Keyword Inventory Database 124.

In an exemplary embodiment, the Performance Analysis component 1206 also can be configured to take the collected performance data, competitive market data, and the like, to determine the optimal, best available, and the like, pricing for a desired rank for a keyword or phrase that the Advertiser 102 chooses to associate with the corresponding campaigns, listings, and the like, of the Advertiser 102. Pricing for various options, such as Super Placement, is possible and can include the price determined to ensure top placement for a keyword, phrase, and the like, when competing against other competitive P4P Listing Engines 1214.

In an exemplary embodiment, such pricing can vary depending on the chosen P4P Listing Engine 1214 for placement, due to the fact that each Distribution Partner 108 for a particular Listing Engine 1214 can collect listings from a different set of the P4P Listing Engines 1214. Because of this, the exemplary embodiments ensure that the Advertiser 102 is provided with the best possible choice of CPC levels that, as accurately as possible, place the Advertiser 102 in the desired rank when the Advertiser 102 appears in the query results of the Distribution Partner 108. For example, if competitive pricing data is collected from the P4P Listing Engines 1214, A, B and C, and the Advertiser 102 employs the exemplary system 1200 for placement for listings in the P4P Listing Engine 1214, D, which competes against listings from the Listing Engines 1214, A and B, in results of the Distribution Partner 108, then the competitive pricing data from the Listing Engines 1214, A and B, can be weighted much higher than the data from the Listing Engine 1214, C, for the Advertiser 102. This will allow the Advertiser 102 to choose various options, such as Super Placement, which, if chosen, allow such listings of the Advertiser 102 to beat out all other competitors for the corresponding keyword in any of the P4P Listing Engines 1214.

In an exemplary embodiment, the Advertiser 102 can use the Advertiser User Interface 122 to manage corresponding campaigns of listings for the Advertiser 102. When inserting a new campaign, listing, and the like, into a Campaigns Database 1204 for being served on the Search Engine 126, the Advertiser User Interface 122 is configured to query the Keyword Inventory Database 124, which returns the pricing information for the desired keywords to be placed in the targeted P4P Listing Engines 1214.

In an exemplary embodiment, the Advertiser User Interface 122 allows the Advertiser 102 to select a list of keywords that the Advertiser 102 desires to associate with the corresponding listings, campaigns, and the like, of the Advertiser 102. The Advertiser User Interface 122 can be configured to perform a process of keyword refinement to propose other suggested keywords that are related to the chosen keywords, to correct misspellings, and the like. In a further exemplary embodiment, the Advertiser User Interface 122 can be configured to automatically opt advertisers into misspellings, plurals, and the like, of keywords, any other suitable business rules, and the like.

In an exemplary embodiment, the Advertiser User Interface 122 can be configured to assist the Advertiser 102 in choosing the best available CPC for listings of the Advertiser 102, for example, based on the budget, time allocation, and the like, of the Advertiser 102. Such factors can be used to determine the Throttle Value for the campaign, and which can be used to determine how to deliver the listings of the Advertiser 102, when to place the listings of the Advertiser 102 in the query results, and the like.

In an exemplary embodiment, the Advertiser User Interface 122 also can be configured to display performance data for desired keywords, phrases, and the like, including expected number of queries, impressions, clicks, conversions, and the like, for the chosen CPC, given the performance metric data recorded in the Keyword Inventory Database 124. Once the listings of the Advertiser 102 are inserted into the Campaigns Database 1204, the listings can be served via the Search Engine 126 to show up as results to the End User 110, directly or through the Distribution Partner 108, when the associated keyword, phrase, and the like, matches an incoming query of the End User 110.

In an exemplary embodiment, the End User 110 can issue a query for a keyword, phrase, and the like, directly to the Search Engine 126 or through the Distribution Partner 108. The Search Engine 126 can respond to the query by searching the Campaigns Database 1204 for results matching the queried keyword, phrase, and the like. The query, the set of matching results, impressions, and the like, then can be recorded for later analysis by the Performance Analysis component 1206. If the End User 110 clicks on a matching result, performs a conversion, acquisition, and the like, the resulting data can be sent back to the Search Engine 126, and recorded for analysis by the Performance Analysis component 1206.

Over time, the analysis performed by the Performance Analysis component 1206 of query, impression, click, conversion, and the like, traffic data for specific keywords can be used determine relative market strength, demand, and the like, for the corresponding keywords, phrases, and the like, in a distribution base for a given of the P4P Listing Engines 1214 and 1202. The Performance Analysis component 1206 can be configured to analyze live, real-time, near real-time, and the like, traffic data from the P4P Listing Engines 1214, as well as traffic data from other sources, where such data can be raw, pre-compiled, already analyzed, and the like. This feature can be employed to determine strength, demand, and the like, data for keyword, phrases, and the like, where access to live, real-time, near real-time, and the like, traffic data is not available, is undesirable to employ, and the like.

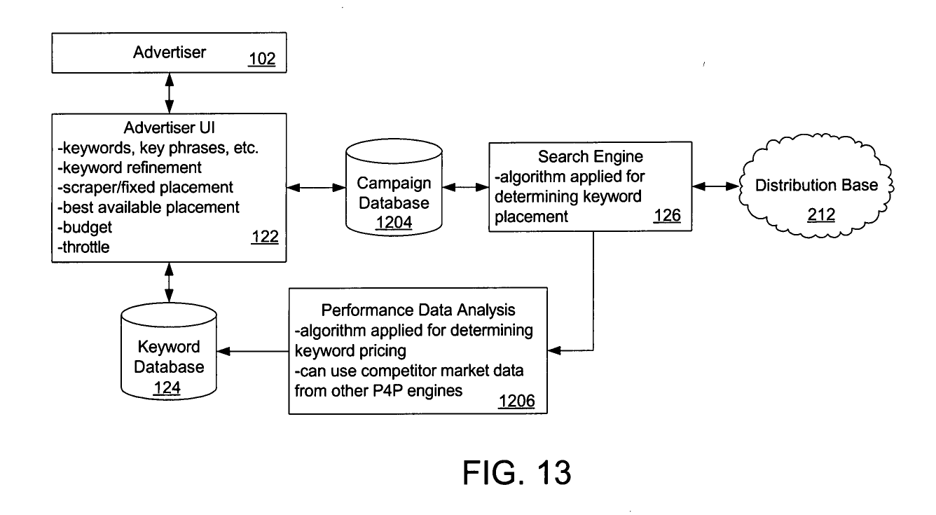

FIG. 13 illustrates exemplary processes that can be performed on the exemplary online advertising system 1200 of FIG. 12, and which can operate in a similar manner as described with respect to FIG. 2. In FIG. 13, the Advertiser 102 can log into the Advertiser User Interface 122 to select keywords, phrases, and the like, wherein an exemplary refinement process can be configured to return other keywords, phrases, and the like, such as other related, suggested, and the like, keywords, phrases, and the like, to correct misspellings, and the like. By querying the Keyword Inventory Database 124, the Advertiser User Interface 122 can be configured to present the best available placement for different CPCs, and allow the Advertiser 102 to choose a budget, which can be used to determine the Throttle Value for the corresponding listing. Such listings can be inserted into the Campaigns Database 1204, and then the listing can be served through the Search Engine 126, as a matching result to an incoming query from the Distribution Base 212. The actual placement of such matching listing can be determined by an algorithm, which employs the CPC level, the Throttle Value, and the like.

In an exemplary embodiment, queries, impressions, clicks, conversions, and the like, can be sent back from the Search Engine 126 for analysis by the Performance Analysis component 1206, which can use competitor keyword data from the other P4P Listing Engines 1214, collected performance data, and the like, to determine keyword pricing, which then can be stored in the Keyword Database 124.

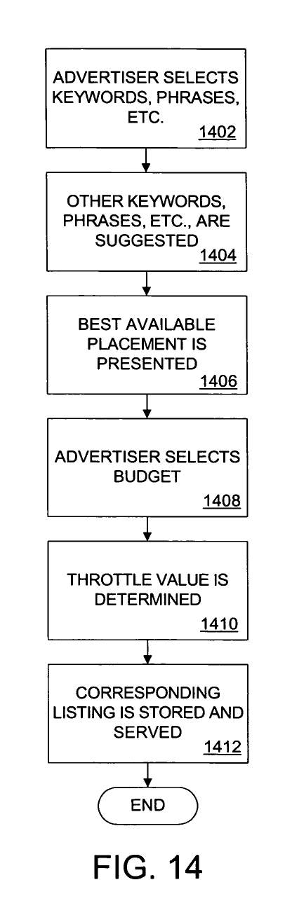

FIG. 14 is a flowchart for illustrating exemplary processes that can be performed on the exemplary online advertising system of FIG. 12. In FIG. 14, at step 1402, an advertiser can select keywords, phrases, and the like. At step 1404, other keywords, phrases, and the like, such as other related, suggested, and the like, keywords, phrases, and the like, corrected misspellings, and the like, can be returned in response to step 1402.

At step 1406, the best available placement for different CPCs can be presented to the advertiser. At step 1408, the advertiser can choose a budget, which, at step 1410, can be used to determine a Throttle Value for the corresponding listing. At step 1412, such listing can be stored in a database, and then the listing can be served through a search engine, as a matching result to an incoming query from a distribution base. The actual placement of such matching listing can be determined by an algorithm, which can employ a CPC level, a Throttle Value, and the like.

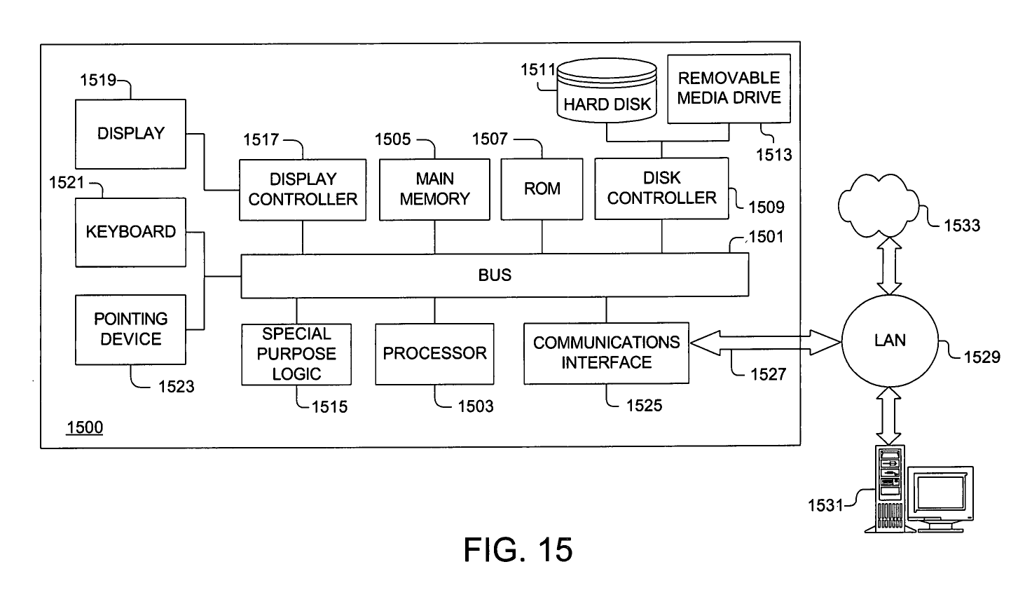

The above-described devices and subsystems of the exemplary embodiments of FIGS. 1-14 can include, for example, any suitable servers, workstations, Personal Computers (PCs), laptop computers, Personal Digital Assistants (PDAs), Internet appliances, handheld devices, cellular telephones, wireless devices, other devices, etc., capable of performing the processes of the exemplary embodiments. The devices and subsystems can communicate with each other using any suitable protocol and can be implemented using the computer system 1500 of FIG. 15, for example.

One or more interface mechanisms can be used in the exemplary embodiments of FIGS. 1-14 including, for example, Internet access, telecommunications in any form (e.g., voice, modem, etc.), wireless communications media, etc. Accordingly, communications networks employed in the exemplary embodiments of FIGS. 1-14 can include, for example, one or more wired or wireless communications networks, cellular communications networks, G3 communications networks, Public Switched Telephone Network (PSTNs), Packet Data Networks (PDNs), the Internet, intranets, and/or any suitable combination thereof, etc.

It is to be understood that the exemplary embodiments of FIGS. 1-14 are for exemplary purposes, as many variations of the specific hardware used to implement the described embodiments are possible, as can be appreciated by those skilled in the relevant art(s). For example, the functionality of the devices and the subsystems of the exemplary embodiments of FIGS. 1-14 can be implemented via one or more programmed computer systems or devices.

To implement such variations as well as other variations, a single computer system (e.g., the computer system 1500 of FIG. 15) can be programmed to perform the special purpose functions of one or more of the devices and subsystems of the exemplary embodiments of FIGS. 1-14. On the other hand, two or more programmed computer systems or devices can be substituted for any one of the devices and subsystems of the exemplary embodiments of FIGS. 1-14. Accordingly, principles and advantages of distributed processing, such as redundancy, replication, etc., also can be implemented, as desired, for example, to increase the robustness and performance of the exemplary embodiments of FIGS. 1-14.

The devices and subsystems of the exemplary embodiments of FIGS. 1-14 can store information relating to various exemplary processes described herein. This information can be stored in one or more memories, such as a hard disk, optical disk, magneto-optical disk, RAM, etc., of the devices and subsystems of the exemplary embodiments of FIGS. 1-14. One or more databases of the devices and subsystems of the exemplary embodiments of FIGS. 1-14 can store the information used to implement the exemplary embodiments of the present invention. The databases can be organized using data structures (e.g., records, tables, arrays, fields, graphs, trees, and/or lists) included in one or more memories, such as the memories listed above or any of the storage devices listed below in the discussion of FIG. 15, for example.

The previously described processes can include appropriate data structures for storing data collected and/or generated by the processes of the exemplary embodiments of FIGS. 1-14 in one or more databases thereof. Such data structures accordingly can include fields for storing such collected and/or generated data. In a database management system, data can be stored in one or more data containers, each container including records, and the data within each record can be organized into one or more fields. In relational database systems, the data containers can be referred to as tables, the records can be referred to as rows, and the fields can be referred to as columns. In object-oriented databases, the data containers can be referred to as object classes, the records can be referred to as objects, and the fields can be referred to as attributes. Other database architectures can be employed and use other terminology. Systems that implement the embodiments of the present invention are not limited to any particular type of data container or database architecture.

All or a portion of the exemplary embodiments of FIGS. 1-14 can be conveniently implemented using one or more conventional general purpose computer systems, microprocessors, digital signal processors, micro-controllers, etc., programmed according to the teachings of the embodiments of the present invention (e.g., using the computer system of FIG. 15), as can be appreciated by those skilled in the computer and software art(s). Appropriate software can be readily prepared by programmers of ordinary skill based on the teachings of the present disclosure, as can be appreciated by those skilled in the software art. Further, the exemplary embodiments of FIGS. 1-14 can be implemented on the World Wide Web (e.g., using the computer system of FIG. 15). In addition, the exemplary embodiments of FIGS. 1-14 can be implemented by the preparation of application-specific integrated circuits or by interconnecting an appropriate network of conventional component circuits, as can be appreciated by those skilled in the electrical art(s).

FIG. 15 illustrates a computer system 1500 upon which the exemplary embodiments of FIGS. 1-14 can be implemented. The various embodiments can be implemented on a single such computer system, or a collection of multiple such computer systems. The computer system 1500 can include a bus 1501 or other communication mechanism for communicating information, and a processor 1503 coupled to the bus 1501 for processing the information. The computer system 1500 also can include a main memory 1505, such as a random access memory (RAM), other dynamic storage device (e.g., dynamic RAM (DRAM), static RAM (SRAM), synchronous DRAM (SDRAM)), etc., coupled to the bus 1501 for storing information and instructions to be executed by the processor 1503.

In addition, the main memory 1505 also can be used for storing temporary variables or other intermediate information during the execution of instructions by the processor 1503. The computer system 1500 further can include a ROM 1507 or other static storage device (e.g., programmable ROM (PROM), erasable PROM (EPROM), electrically erasable PROM (EEPROM), etc.) coupled to the bus 1501 for storing static information and instructions.

The computer system 1500 also can include a disk controller 1509 coupled to the bus 1501 to control one or more storage devices for storing information and instructions, such as a magnetic hard disk 1511, and a removable media drive 1513 (e.g., floppy disk drive, read-only compact disc drive, read/write compact disc drive, compact disc jukebox, tape drive, and removable magneto-optical drive). The storage devices can be added to the computer system 1500 using an appropriate device interface (e.g., small computer system interface (SCSI), integrated device electronics (IDE), enhanced-IDE (E-IDE), direct memory access (DMA), or ultra-DMA).

The computer system 1500 also can include special purpose logic devices 1515, such as application specific integrated circuits (ASICs), full custom chips, configurable logic devices (e.g., simple programmable logic devices (SPLDs), complex programmable logic devices (CPLDs), field programmable gate arrays (FPGAs), etc.), and the like, for performing special processing functions, such as signal processing, image processing, speech processing, voice recognition, communications functions, advertisement generating and serving functions, etc.

The computer system 1500 also can include a display controller 1517 coupled to the bus 1501 to control a display 1519, such as a cathode ray tube (CRT), television display, liquid crystal display (LCD), active matrix display, plasma display, touch display, etc., for displaying or conveying information to a computer user. The computer system can include input devices, such as a keyboard 1521 including alphanumeric and other keys and a pointing device 1523, for interacting with a computer user and providing information to the processor 1503. The pointing device 1523 can include, for example, a mouse, a trackball, a pointing stick, etc., or voice recognition processor, etc., for communicating direction information and command selections to the processor 1503 and for controlling cursor movement on the display 1519. In addition, a printer can provide printed listings of the data structures/information of the exemplary embodiments of FIGS. 1-14 or any other data stored and/or generated by the computer system 1500.

The computer system 1500 can perform a portion or all of the processing steps of the invention in response to the processor 1503 executing one or more sequences of one or more instructions contained in a memory, such as the main memory 1505. Such instructions can be read into the main memory 1505 from another computer readable medium, such as the hard disk 1511 or the removable media drive 1513. Execution of the arrangement of instructions contained in the main memory 1505 causes the processor 1503 to perform the process steps described herein. One or more processors in a multi-processing arrangement also can be employed to execute the sequences of instructions contained in the main memory 1505. In alternative embodiments, hard-wired circuitry can be used in place of or in combination with software instructions. Thus, embodiments are not limited to any specific combination of hardware circuitry and/or software.

Stored on any one or on a combination of computer readable media, the embodiments of the present invention can include software for controlling the computer system 1500, for driving a device or devices for implementing the invention, and for enabling the computer system 1500 to interact with a human user (e.g., users of the exemplary embodiments of FIGS. 1-14). Such software can include, but is not limited to, device drivers, firmware, operating systems, development tools, applications software, etc. Such computer readable media further can include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

The computer system 1500 also can include a communication interface 1525 coupled to the bus 1501. The communication interface 1525 can provide a two-way data communication coupling to a network link 1527 that is connected to, for example, a local area network (LAN) 1529, or to another communications network 1533 (e.g. a wide area network (WAN), a global packet data communication network, such as the Internet, etc.). For example, the communication interface 1525 can include a digital subscriber line (DSL) card or modem, an integrated services digital network (ISDN) card, a cable modem, a telephone modem, etc., to provide a data communication connection to a corresponding type of telephone line. As another example, the communication interface 1525 can include a local area network (LAN) card (e.g., for Ethernet, an Asynchronous Transfer Model (ATM) network, etc.), and the like, to provide a data communication connection to a compatible LAN. Wireless links also can be implemented. In any such implementation, the communication interface 1525 can send and receive electrical, electromagnetic, or optical signals that carry digital data streams representing various types of information. Further, the communication interface 1525 can include peripheral interface devices, such as a Universal Serial Bus (USB) interface, a PCMCIA (Personal Computer Memory Card International Association) interface, etc.

The network link 1527 typically can provide data communication through one or more networks to other data devices. For example, the network link 1527 can provide a connection through the LAN 1529 to a host computer 1531, which has connectivity to the network 1533 or to data equipment operated by a service provider. The LAN 1529 and the network 1533 both can employ electrical, electromagnetic, or optical signals to convey information and instructions. The signals through the various networks and the signals on the network link 1527 and through the communication interface 1525, which communicate digital data with computer system 1500, are exemplary forms of carrier waves bearing the information and instructions.

The computer system 1500 can send messages and receive data, including program code, through the network 1529 and/or 1533, the network link 1527, and the communication interface 1525. In the Internet example, a server can transmit requested code belonging to an application program for implementing an embodiment of the present invention through the network 1533, the LAN 1529 and the communication interface 1525. The processor 1503 can execute the transmitted code while being received and/or store the code in the storage devices 1511 or 1513, or other non-volatile storage for later execution. In this manner, computer system 1500 can obtain application code in the form of a carrier wave. With the system of FIG. 15, the embodiments of the present invention can be implemented on the Internet as a Web Server 1500 performing one or more of the processes according to the embodiments of the present invention for one or more computers coupled to the Web server 1500 through the network 1533 coupled to the network link 1527.

The term computer readable medium as used herein can refer to any medium that participates in providing instructions to the processor 1503 for execution. Such a medium can take many forms, including but not limited to, non-volatile media, volatile media, transmission media, etc. Non-volatile media can include, for example, optical or magnetic disks, magneto-optical disks, etc., such as the hard disk 1511 or the removable media drive 1513. Volatile media can include dynamic memory, etc., such as the main memory 1505. Transmission media can include coaxial cables, copper wire and fiber optics, including the wires that make up the bus 1501. Transmission media also can take the form of acoustic, optical, or electromagnetic waves, such as those generated during radio frequency (RF) and infrared (IR) data communications.

As stated above, the computer system 1500 can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to either of the networks 1529 and 1533. In such a scenario, the remote computer can load the instructions into main memory and send the instructions, for example, over a telephone line using a modem. A modem of a local computer system can receive the data on the telephone line and use an infrared transmitter to convert the data to an infrared signal and transmit the infrared signal to a portable computing device, such as a PDA, a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on storage device either before or after execution by processor.

Although the exemplary embodiments are described in terms of distributing advertisements by partner querying, the present invention can include distributing advertisements by inserting advertisements into external engines, for example, via an API, User Interface, etc., of an external engine.

Although the exemplary embodiments are described in terms of online advertising, the present invention is applicable to other forms of advertising, for example, including print advertising, radio advertising, TV advertising, direct mail advertising, and the like, as can be appreciated by those skilled in the relevant art(s).

While the present invention has been described in connection with a number of exemplary embodiments and implementations, the present invention is not so limited but rather covers various modifications and equivalent arrangements, which fall within the purview of the appended claims.

1. A method for online advertising, comprising:
generating pricing for an advertisement campaign of an advertiser paying on a Cost-Per-Click (CPC) basis or Cost-Per-Acquisition (CPA) based on internal tracking metrics and/or pricing and performance analysis of advertisements from an advertising distribution network; and
distributing the advertisement as a CPC-based advertisement and/or CPA-based advertisement to an advertising distribution network.

2. The method of claim 1, comprising tracking a number of clicks that are generated by the advertisement, and a time of actual conversion or acquisition, including a deferred conversion.

3. The method of claim 1, comprising tracking standard conversions that occur during a session in which a user clicks on the advertisement.

4. The method of claim 1, comprising distributing the advertisement to the advertising distribution network, including one of a cost-per-1,000 (CPM) advertising distribution network, a CPC advertising distribution network, and a CPA advertising distribution network.

5. The method of claim 1, comprising distributing the advertisement in a CPC-equivalent format, a CPM-equivalent format, and/or a CPA format.

6. The method of claim 1, comprising tracking end user click-throughs, conversions, and/or end user acquisitions, associated with the advertisement, based on tracking the end user, directly tracking conversion information on a site of the advertiser, and/or the advertiser returning conversion information.

7. The method of claim 1, comprising tracking standard conversions that occur outside a session in which a user clicks on the advertisement.

8. The method of claim 1, comprising tracking standard conversions that occur in a session separate than a session in which a user clicks on the advertisement.

9. The method of claim 1, comprising factoring in distribution costs of a pay-for-performance search engine(PFPSE), when determining the CPC for a keyword or phrase associated with the advertisement.

10. The method of claim 1, comprising factoring in desired ranking and placement on particular distribution partners or across a distribution network, when determining the CPC for a keyword or phrase associated with the advertisement.

11. The method of claim 4, wherein the advertising distribution network is an online-based advertising distribution network.

12. The method of claim 4, wherein the advertising distribution network is an Internet-based advertising distribution network.

13. The method of claim 1, wherein the advertising distribution network for generating the pricing for the advertisement campaign includes a pay-for-performance search engine (PFPSE).

14. A computer program product comprising one or more computer-readable instructions configured to cause one or more computer processors to execute the steps recited in claim 1.

15. A computer system comprising one or more computer processors configured to execute the steps recited in claim 1.

16. An online advertising system, comprising:
means for generating pricing for an advertisement campaign of an advertiser paying on a Cost-Per-Click (CPC) basis or Cost-Per-Acquisition (CPA) based on internal tracking metrics and/or pricing and performance analysis of advertisements from an advertising distribution network; and
means for distributing the advertisement as a CPC-based advertisement and/or CPA-based advertisement to an advertising distribution network.

17. The system of claim 16, comprising means for tracking a number of clicks that are generated by the advertisement, and a time of actual conversion or acquisition, including a deferred conversion.

18. The system of claim 16, comprising means for tracking standard conversions that occur during a session in which a user clicks on the advertisement.

19. The system of claim 16, comprising means for distributing the advertisement to the advertising distribution network, including one of a cost-per-1,000 (CPM) advertising distribution network, a CPC advertising distribution network, and a CPA advertising distribution network.

20. The system of claim 16, comprising means for distributing the advertisement in a CPC-equivalent format, a CPM-equivalent format, and/or a CPA format.

21. The system of claim 16, comprising means for tracking end user click-throughs, conversions, and/or end user acquisitions, associated with the advertisement, based on tracking the end user, directly tracking conversion information on a site of the advertiser, and/or the advertiser returning conversion information.

22. The system of claim 16, comprising means for tracking standard conversions that occur outside a session in which a user clicks on the advertisement.

23. The system of claim 16, comprising means for tracking standard conversions that occur in a session separate than a session in which a user clicks on the advertisement.

24. The system of claim 16, comprising means for factoring in distribution costs of a pay-for-performance search engine (PFPSE), when determining the CPC for a keyword or phrase associated with the advertisement.

25. The system of claim 16, comprising means for factoring in desired ranking and placement on particular distribution partners or across a distribution network, when determining the CPC for a keyword or phrase associated with the advertisement.

26. The system of claim 19, wherein the advertising distribution network is an online-based advertising distribution network.

27. The system of claim 19, wherein the advertising distribution network is an Internet-based advertising distribution network.

28. The system of claim 16, wherein the advertising distribution network for generating the pricing for the advertisement campaign includes a pay-for-performance search engine (PFPSE).
